(19) United States
(12) Patent Application Publication
(10) Pub. No.: US 2023/0243975 A1
(43) Pub. Date: Aug. 3, 2023

(54) Logic For Controlling Histogramming Of Measurements Of Lidar Sensors

(71) Applicant: Ouster, Inc., San Francisco, CA (US)

(72) Inventors: Aaron Jaffey, Santa Clara, CA (US); David Storrar, Falkirk (GB); Angus Pacala, San Francisco, CA (US)

(73) Assignee: Ouster, Inc., San Francisco, CA (US)

(21) Appl. No.: 18/150,961

(22) Filed: Jan. 6, 2023

Related U.S. Application Data
(60) Provisional application No. 63/297,663, filed on Jan. 7, 2022.

(51) Int. Cl. G01S 17/894; G01S 17/14; G01S 7/4863; G01S 7/4865

(52) U.S. Cl. CPC G01S 17/894; G01S 7/4863; G01S 7/4866; G01S 17/14

(57) ABSTRACT

A lidar system may include a programmable configuration memory, configured to receive configuration values for controlling histogramming operations performed by the lidar system. The lidar system may also include an array controller, configured or programmed or set to read the configuration values and send control signals according to the configuration values in the programmable configuration memory. The lidar system may also include a sensor array, where the sensor array includes a plurality of pixels. Each pixel in the plurality of pixels may include a photosensor, summation circuitry, and a memory device. Each of the plurality of pixels may be configured to generate histogram data by collecting photon counts during a plurality of time bins for each of a plurality of laser cycles.

### CROSS-REFERENCES TO RELATED APPLICATIONS

The present application claims priority from and is a non-provisional application of U.S. Provisional Application No. 63/297,663, entitled “Logic For Controlling Histogramming Of Measurements Of Lidar Sensors” filed Jan. 7, 2022, the entire contents of which is herein incorporated by reference for all purposes.

### BACKGROUND

This disclosure relates generally to lidar systems and more specifically to configurable lidar systems.

Time of flight (ToF) based imaging is used in a number of applications, including range finding, depth profiling, and 3D imaging, such as light imaging, detection, and ranging (LiDAR, or lidar). Direct time of flight (dToF) measurement includes directly measuring the length of time between emitting radiation from emitter element(s) and sensing the radiation by detector element(s) after reflection from an object or other target. The distance to the target can be determined from the measured length of time. Indirect time of flight measurement includes determining the distance to the target by phase modulating the amplitude of the signals emitted by the emitter element(s) of the lidar system and measuring phases (e.g., with respect to delay or shift) of the echo signals received at the detector element(s) of the lidar system. These phases may be measured with a series of separate measurements or samples.

In specific applications, the sensing of the reflected radiation in either direct or indirect time of flight systems may be performed using an array of detectors, such as an array of Single Photon Avalanche Diodes (SPADs). One or more detectors may define a sensor of the sensor array used to generate a lidar image for the depth (range) to objects for respective pixels of an image or point cloud.

When imaging a scene, ToF sensors (also referred to as photosensors) for lidar applications can include circuits that time-stamp and/or count incident photons as reflected from a target. Data rates can be compressed by histogramming timestamps. For instance, for each pixel, a histogram having bins (also referred to as “time bins”) corresponding to different ranges of photon arrival times can be stored in memory, and photon counts can be accumulated in different time bins of the histogram according to their arrival time. A time bin can correspond to a time range of, e.g., 1 ns, 2 ns, or the like.

Some lidar systems may perform in-pixel histogramming of incoming photons using a clock-driven architecture and a limited memory block, which may provide a significant increase in histogramming capacity. However, since memory capacity is limited and typically cannot cover the desired distance range at once, such lidar systems may operate in “strobing” mode. “Strobing” can refer to the generation of detector control signals (also referred to herein as “strobe signals” or “strobes”) to control the timing and/or duration of activation (also referred to herein as “detection windows” or “strobe windows”) of one or more detectors of the lidar system, such that photon detection and histogramming is performed sequentially over a set of different time windows, each corresponding to an individual distance subrange, so as to collectively define the entire distance range. In other words, partial histograms may be acquired for subranges or “time slices” corresponding to different sub-ranges of the distance range and then amalgamated into one full-range histogram. Thousands of time bins (each corresponding to respective photon arrival times) may typically be used to form a histogram sufficient to cover the typical time range of a lidar system (e.g., microseconds) with the typical time-to-digital converter (TDC) resolution (e.g., 50 to 100 picoseconds).

Applications for lidar devices can vary, and thus there is a need for lidar devices to perform accurately in various use cases.

### BRIEF SUMMARY

In some embodiments, a Light Detection and Ranging (lidar) system is disclosed. The lidar system may include a programmable configuration memory, configured to receive configuration values for controlling histogramming operations performed by the lidar system. The lidar system may also include an array controller, configured or programmed or set to read the configuration values and send control signals according to the configuration values in the programmable configuration memory. The lidar system may also include a sensor array, where the sensor array includes a plurality of pixels. Each pixel in the plurality of pixels may include a photosensor, summation circuitry, and a memory device. Each of the plurality of pixels may be configured to generate histogram data by collecting photon counts during a plurality of time bins for each of a plurality of laser cycles.

In some embodiments, the array controller may be configured or programmed or set to enter a mode based on one or more configuration values. The array controller may also obtain one or more histogramming parameters. The one or more histogramming parameters may include a histogramming start time, a histogramming time bin range, and a scheduled histogram data readout.

In some embodiments, the plurality of pixels may be configured to collect photon counts at a histogramming start time associated with each of the plurality of laser cycles, in accordance with the control signals. The histogramming start time for each of the plurality of pixels may be independently configurable.

In some embodiments, the sensor array may be configured to generate a readout of histogram data during a histogram cycle in accordance with the control signals. The readout of the histogram data may be generated after a predetermined number of time bins pass, as counted from a first time bin. The predetermined number of time bins may be in accordance with the control signals. The readout of the histogram data may be generated after a predetermined number of laser cycles are completed. The predetermined number of laser cycles may by in accordance with the control signals. In some embodiments, the readout of the histogram data may be generated in between laser cycles.

In some embodiments, the control signals may specify a histogramming time bin range comprising a set of consecutive time bins. Each of the plurality of pixels may be configured to generate histogram data for the set of consecutive time bins. In some embodiments, the histogramming time bin range may be less than a total number of time bins included in a laser cycle.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings. It is to be understood, however, that each of the figures is provided for the purpose of illustration only and is not intended as a definition of the limits of the scope of the invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified block diagram of a Light Detection and Ranging (lidar) system according to some embodiments;

FIG. 2 is a simplified block diagram of components of a time-of-flight measurement system or circuit according to some embodiments;

FIG. 3 illustrates the operation of a typical lidar system that may be improved by embodiments;

FIG. 4 shows a histogram according to embodiments of the present invention;

FIG. 5 shows the accumulation of a histogram over multiple pulse trains for a selected pixel according to embodiments of the present invention;

FIG. 6 shows simplified example of a lidar system, according to embodiments of the present invention;

FIG. 7 shows a system for controlling a histogramming start time on a per-shot basis according to embodiments of the present invention;

FIG. 8 shows a method of controlling a histogramming cycle on a bin-by-bin basis according to embodiments of the present invention;

FIG. 9 shows a system for reading out histogram data during a histogramming cycle, according to embodiments of the present invention;

FIG. 10 shows a method of reading out histogram data during a histogramming cycle, according to embodiments of the present invention;

FIG. 11 shows a method of limiting a pixel histogram by time bin range, according to embodiments of the present invention.

FIG. 12 is a simplified illustration of an automobile in which multiple solid state flash lidar sensors according to some embodiments are included at different locations along the vehicle.

### DETAILED DESCRIPTION

Different end users of a lidar system may wish to use a lidar system in different ways, e.g., for long range detection, short range detection, or a dynamic range that spans short and long distances. To achieve configurability, embodiments can have configuration logic (e.g., in an array controller) that provide control signals to a sensor array. These control signals can configure the operations of the sensor array, e.g., to create a histogram in a particular way. Such configurations can control operations for an entire measurement frame or at individual laser cycles. In this manner, the sensor array can be an ASIC that operates based on various control signals, and a controller can be programmed (e.g., in an FPGA) by an end user so the lidar system operates as desired for a particular application.

This disclosure provides various examples of types of control signals and types of operations than can be controlled for a sensor array that detected light pulses emitted by a lidar system. For example, when to begin and end histogramming for an entire frame, but also on a per pixel basis and on a per shot basis (e.g., laser cycle), may be desirable in certain circumstances. For instance, controlling when histograms are collected for certain time bins may lead to more accurate measurements of the distance to a target object and/or more energy efficient operations. Furthermore, determining which time bins to use in a histogram may lead to greater efficiency in only collecting data on an expected target or region.

### I. Example Lidar System

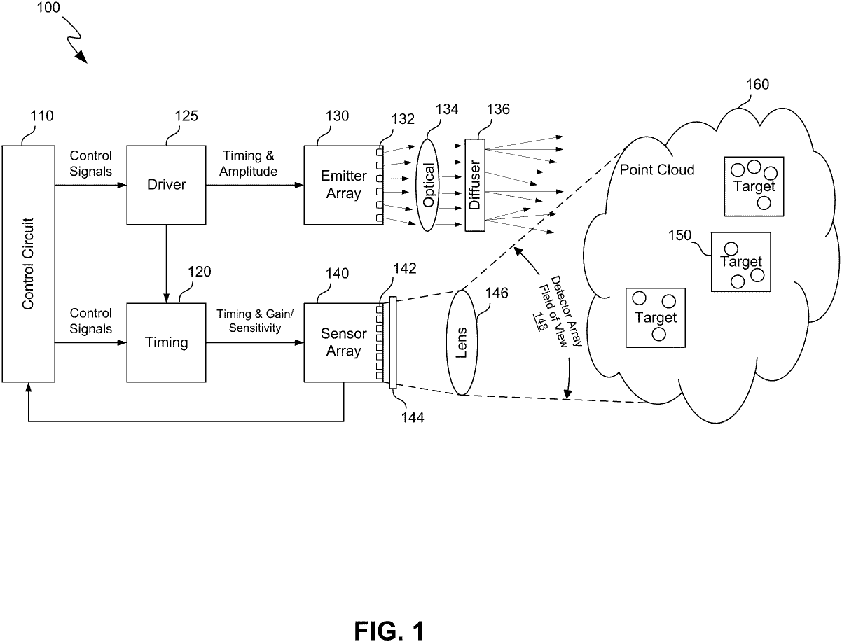

FIG. 1 illustrates an example light-based 3D sensor system 100, such as a Light Detection and Ranging (LiDAR, or lidar) system, in accordance with some embodiments of the present disclosure. Lidar system 100 can include a control circuit 110, a timing circuit 120, driver circuitry 125, an emitter array 130 and a sensor array 140. Emitter array 130 can include a plurality of emitter units 132 arranged in an array (e.g., a one- or two-dimensional array) and sensor array 140 can include a plurality of sensors 142 arranged in an array (e.g., a one- or two-dimensional array). Sensors 142 can corresponds to pixels, which may include additional circuitry. The sensors 142 can be depth sensors, such as time-of-flight ToF sensors. In some embodiments, each sensor 142 can include, for example, an array of single-photon detectors, such as single-photon avalanche diodes (SPADs). In some embodiments, each sensor 142 can be coupled to an in-pixel memory block (not shown) that accumulates histogram data for that sensor 142, and the combination of a sensor and in-pixel memory circuitry is sometimes referred to as a “pixel.” Each emitter unit 132 of the emitter array 130 can include one or more emitter elements that can emit a radiation pulse (e.g., light pulse) or continuous wave signal at a time and frequency controlled by a timing generator or driver circuitry 125. In some embodiments, the emitter units 132 can be pulsed light sources, such as LEDs or lasers such as vertical cavity surface emitting lasers (VCSELs) that emit a cone of light (e.g., infrared light) having a predetermined beam divergence.

Emitter array 130 can project pulses of radiation into a field of view of the lidar system 100. Some of the emitted radiation can then be reflected back from objects in the field, such as targets 150. The radiation that is reflected back can then be sensed or detected by the sensors 142 within the sensor array 140. Control circuit 110 can implement a processor that measures and/or calculates the distance to targets 150 based on data (e.g., histogram data) provided by sensors 142. In some embodiments, control circuit 110 can measure and/or calculate the time of flight of the radiation pulses over the journey from emitter array 130 to target 150 and back to the sensors 142 within the sensor array 140 using direct or indirect time of flight (ToF) measurement techniques.

In some embodiments, emitter array 130 can include an array (e.g., a one- or two-dimensional array) of emitter units 132 where each emitter unit is a unique semiconductor chip having one or more individual VCSELs (sometimes referred to herein as emitter elements) formed on the chip. An optical element 134 and a diffuser 136 can be disposed in front of the emitter units such that light projected by the emitter units passes through the optical element 134 (which can include, e.g., one or more Fresnel lenses) and then through diffuser 136 prior to exiting lidar system 100. In some embodiments, optical element 134 can be an array of lenses or lenslets (in which case the optical element is sometimes referred to herein as “lens array 134” or “lenslet array 134”) that collimate or reduce the angle of divergence of light received at the array and pass the altered light to diffuser 136. The diffuser 136 can be designed to spread light received at the diffuser over an area in the field that can be referred to as the field of view of the emitter array (or the field of illumination of the emitter array). In general, in these embodiments, emitter array 130, lens array 134 and diffuser 136 cooperate to spread light from emitter array 130 across the entire field of view of the emitter array. A variety of emitters and optical components can be used.

The driver circuitry 125 can include one or more driver circuits each of which controls one or more emitter units. The driver circuits can be operated responsive to timing control signals with reference to a master clock and/or power control signals that control the peak power and/or the repetition rate of the light output by the emitter units 132. In some embodiments, each of the emitter units 132 in the emitter array 130 is connected to and controlled by a separate circuit in driver circuitry 125. In other embodiments, a group of emitter units 132 in the emitter array 130 (e.g., emitter units 132 in spatial proximity to each other or in a common column of the emitter array), can be connected to a same circuit within driver circuitry 125. Driver circuitry 125 can include one or more driver transistors configured to control the modulation frequency, timing, and/or amplitude of the light (optical emission signals) output from the emitter units 132.

In some embodiments, a single event of emitting light from the multiple emitter units 132 can illuminate an entire image frame (or field of view); this is sometimes referred to as a “flash” lidar system. Other embodiments can include non-flash or scanning lidar systems, in which different emitter units 132 emit light pulses at different times, e.g., into different portions of the field of view. The maximum optical power output of the emitter units 132 can be selected to generate a signal-to-noise ratio of the echo signal from the farthest, least reflective target at the brightest background illumination conditions that can be detected in accordance with embodiments described herein. In some embodiments, an optical filter (not shown) such as a bandpass filter can be included in the optical path of the emitter units 132 to control the emitted wavelengths of light.

Light output from the emitter units 132 can impinge on and be reflected back to lidar system 100 by one or more targets 150 in the field. The reflected light can be detected as an optical signal (also referred to herein as a return signal, echo signal, or echo) by one or more of the sensors 142 (e.g., after being collected by receiver optics 146), converted into an electrical signal representation (sometimes referred to herein as a detection signal), and processed (e.g., based on time of flight techniques) to define a 3-D point cloud representation 160 of a field of view 148 of the sensor array 140. In some embodiments, operations of lidar systems can be performed by one or more processors or controllers, such as control circuit 110.

Sensor array 140 includes an array of sensors 142. In some embodiments, each sensor 142 can include one or more photodetectors, e.g., SPADs. And in some particular embodiments, sensor array 140 can be a very large array made up of hundreds of thousands or even millions of densely packed SPADs. Receiver optics 146 and receiver electronics (including timing circuit 120) can be coupled to the sensor array 140 to power, enable, and disable all or parts of the sensor array 140 and to provide timing signals thereto. In some embodiments, sensors 142 can be activated or deactivated with at least nanosecond precision (supporting time bins of 1 ns, 2 ns etc.), and in various embodiments, sensors 142 can be individually addressable, addressable by group, and/or globally addressable. The receiver optics 146 can include a bulk optic lens that is configured to collect light from the largest field of view that can be imaged by the lidar system 100, which in some embodiments is determined by the aspect ratio of the sensor array combined with the focal length of the receiver optics 146.

In some embodiments, the receiver optics 146 can further include various lenses (not shown) to improve the collection efficiency of the sensors, and/or an anti-reflective coating (also not shown) to reduce or prevent detection of stray light. In some embodiments, a spectral filter 144 can be positioned in front of the sensor array 140 to pass or allow passage of ‘signal’ light (i.e., light of wavelengths corresponding to wavelengths of the light emitted from the emitter units) but substantially reject or prevent passage of non-signal light (i.e., light of wavelengths different from the wavelengths of the light emitted from the emitter units).

The sensors 142 of sensor array 140 are connected to the timing circuit 120. The timing circuit 120 can be phase-locked to the driver circuitry 125 of emitter array 130. The sensitivity of each of sensors 142 or of groups of sensors 142 can be controlled. For example, when the detector elements include reverse-biased photodiodes, avalanche photodiodes (APD), PIN diodes, and/or Geiger-mode avalanche diodes (e.g., SPADs), the reverse bias can be adjusted. In some embodiments, a higher overbias provides higher sensitivity.

In some embodiments, control circuit 110, which can be, for example, a microcontroller or microprocessor, provides different emitter control signals to the driver circuitry 125 of different emitter units 132 and/or provides different signals (e.g., strobe signals) to the timing circuit 120 of different sensors 142 to enable/disable the different sensors 142 so as to detect the echo signal (or returning light) from the target 150. The control circuit 110 can also control memory storage operations for storing data indicated by the detection signals in a non-transitory memory or memory array that is included therein or is distinct therefrom.

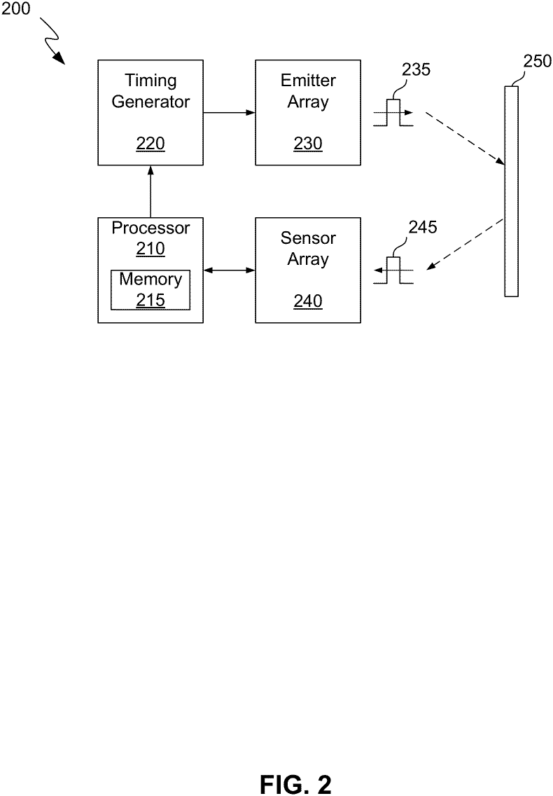

FIG. 2 further illustrates components of a ToF measurement system or circuit 200 in a lidar application in accordance with some embodiments described herein. The circuit 200 can include a processor circuit 210 (such as a digital signal processor (DSP)), a timing generator 220 that controls timing of the illumination source (illustrated by way of example with reference to a laser emitter array 230), and an array of sensors (illustrated by way of example with reference to a sensor array 240). The processor circuit 210 can also include a sequencer circuit (not shown in FIG. 2) that is configured to coordinate operation of emitter units within the illumination source (emitter array 230) and sensors within the sensor array 240.

The processor circuit 210 and the timing generator 220 can implement some of the operations of the control circuit 110 and the driver circuitry 125 of FIG. 1. Similarly, emitter array 230 and sensor array 240 can be representative of emitter array 130 and sensor array 140 in FIG. 1. The laser emitter array 230 can emit laser pulses 235 at times controlled by the timing generator 220. Light 245 from the laser pulses 235 can be reflected back from a target (illustrated by way of example as object 250) and can be sensed by sensor array 240. The processor circuit 210 implements a pixel processor that can measure or calculate the time of flight of each laser pulse 235 and its reflected signal 245 over the journey from emitter array 230 to object 250 and back to the sensor array 240.

The processor circuit 210 can provide analog and/or digital implementations of logic circuits that provide the necessary timing signals (such as quenching and gating or strobe signals) to control operation of single-photon detectors of the sensor array 240 and that process the detection signals output therefrom. For example, individual single-photon detectors of sensor array 240 can be operated such that they generate detection signals in response to incident photons only during the gating intervals or strobe windows that are defined by the strobe signals, while photons that are incident outside the strobe windows have no effect on the outputs of the single photon detectors. More generally, the processor circuit 210 can include one or more circuits that are configured to generate detector control signals that control the timing and/or durations of activation of the sensors 142 (or particular single-photon detectors therein), and/or to generate respective emitter control signals that control the output of light from the emitter units 132.

Detection events can be identified by the processor circuit 210 based on one or more photon counts indicated by the detection signals output from the sensor array 240, which can be stored in a non-transitory memory 215. In some embodiments, the processor circuit 210 can include a correlation circuit or correlator that identifies detection events based on photon counts (referred to herein as correlated photon counts) from two or more single-photon detectors within a predefined window (time bin) of time relative to one another, referred to herein as a correlation window or correlation time, where the detection signals indicate arrival times of incident photons within the correlation window. Since photons corresponding to the optical signals output from the emitter array 230 (also referred to as signal photons) can arrive relatively close in time with each other, as compared to photons corresponding to ambient light (also referred to as background photons), the correlator can be configured to distinguish signal photons based on respective times of arrival being within the correlation time relative to one another. Such correlators and strobe windows are described, for example, in U.S. Pat. Application Publication No. 2019/0250257, entitled “Methods and Systems for High-Resolution Long Range Flash Lidar,” which is incorporated by reference herein in its entirety for all purposes.

The processor circuit 210 can be small enough to allow for three-dimensionally stacked implementations, e.g., with the sensor array 240 “stacked” on top of processor circuit 210 (and other related circuits) that is sized to fit within an area or footprint of the sensor array 240. For example, some embodiments can implement the sensor array 240 on a first substrate, and transistor arrays of the processor circuit 210 on a second substrate, with the first and second substrates/wafers bonded in a stacked arrangement, as described for example in U.S. Pat. Application Publication No. 2020/0135776, entitled “High Quantum Efficiency Geiger-Mode Avalanche Diodes Including High Sensitivity Photon Mixing Structures and Arrays Thereof,” the disclosure of which is incorporated by reference herein in its entirety for all purposes.

The pixel processor implemented by the processor circuit 210 can be configured to calculate an estimate of the average ToF aggregated over hundreds or thousands of laser pulses 235 and photon returns in reflected light 245. The processor circuit 210 can be configured to count incident photons in the reflected light 245 to identify detection events (e.g., based on one or more SPADs within the sensor array 240 that have been “triggered”) over a laser cycle (or portion thereof).

The timings and durations of the detection windows can be controlled by a strobe signal (Strobe#i or Strobe<i>). Many repetitions of Strobe#i can be aggregated (e.g., in the pixel) to define a sub-frame for Strobe#i, with subframes i = 1 to n defining an image frame. Each sub-frame for Strobe#i can correspond to a respective distance sub-range of the overall imaging distance range. In a single-strobe system, a sub-frame for Strobe#i can correspond to the overall imaging distance range and is the same as an image frame since there is a single strobe. The time between emitter unit pulses (which defines a laser cycle, or more generally emitter pulse frequency) can be selected to define or can otherwise correspond to the desired overall imaging distance range for the ToF measurement system 200. Accordingly, some embodiments described herein can utilize range strobing to activate and deactivate sensors for durations or “detection windows” of time over the laser cycle, at variable delays with respect to the firing of the laser, thus capturing reflected correlated signal photons corresponding to specific distance sub-ranges at each window/ frame, e.g., to limit the number of ambient photons acquired in each laser cycle.

The strobing can turn off and on individual photodetectors or groups of photodetectors (e.g., for a pixel), e.g., to save energy during time intervals outside the detection window. For instance, a SPAD or other photodetector can be turned off during idle time, such as after an integration burst of time bins and before a next laser cycle. As another example, SPADs can also be turned off while all or part of a histogram is being read out from non-transitory memory 215. Yet another example is when a counter for a particular time bin reaches the maximum value (also referred to as “bin saturation”) for the allocated bits in the histogram stored in non-transitory memory 215. A control circuit can provide a strobe signal to activate a first subset of the sensors while leaving a second subset of the sensors inactive. In addition or alternatively, circuitry associated with a sensor can also be turned off and on as specified times.

### Ii. Detection of Reflected Pulses

The photosensors can be arranged in a variety of ways for detecting reflected pulses. For example, the photosensors can be arranged in an array, and each photosensor can include an array of photodetectors (e.g., SPADs). A signal from a photodetector indicates when a photon was detected and potentially how many photons were detected. For example, a SPAD can operate in a single-photon detection mode. This single-photon detection mode of operation is often referred to as “Geiger Mode,” and an avalanche can produce a current pulse that results in a photon being counted, which may be output as binary signals. Other photodetectors (e.g., for an avalanche photodiode) can produce an analog signal (in real time) proportional to the number of photons detected. The signals from individual photodetectors can be combined to provide a signal from the sensor, which can be a digital signal. This signal can be used to generate histograms.

### A. Time-of-Flight Measurements and Detectors

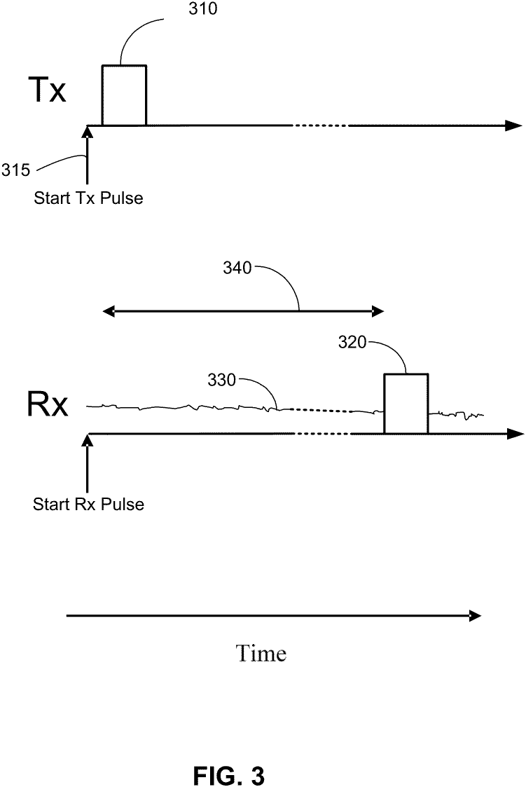

FIG. 3 illustrates the operation of a typical lidar system that may be improved by some embodiments. A laser or other emitter (e.g., within emitter array 230 or emitter array 130) generates a light pulse 310 of short duration. The horizontal axis represents time and the vertical axis represents power. An example laser pulse duration, characterized by the full-width half maximum (FWHM), is a few nanoseconds, with the peak power of a single emitter being around a few watts. Embodiments that use side emitter lasers or fiber lasers may have much higher peak powers, while embodiments with small diameter VCSELs could have peak powers in the tens of milliwatts to hundreds of milliwatts.

A start time 315 for the emission of the pulse does not need to coincide with the leading edge of the pulse. As shown, the leading edge of light pulse 310 may be after the start time 315. One may want the leading edge to differ in situations where different patterns of pulses are transmitted at different times, e.g., for coded pulses. In this example, a single pulse of light is emitted. In some embodiments, a sequence of multiple pulses can be emitted, and the term “pulse train” as used herein refers to either a single pulse or a sequence of pulses.

An optical receiver system (which can include, e.g., sensor array 240 or sensor array 140) can start detecting received light at the same time as the laser is started, i.e., at the start time. In other embodiments, the optical receiver system can start at a later time, which is at a known time after the start time for the pulse. The optical receiver system detects background light 330 initially and after some time detects the laser pulse reflection 320. The optical receiver system can compare the detected light intensity against a threshold to identify the laser pulse reflection 320. Where a sequence of pulses are emitted, the optical receiver system can detect each pulse. The threshold can distinguish the background light 330 from light corresponding to the laser pulse reflection 320.

The time-of-flight 340 is the time difference between the pulse 310 being emitted and the reflected pulse 320 being received. The time difference can be measured by subtracting the emission time of the pulse 310 (e.g., as measured relative to the start time) from a received time of the reflected pulse 320 (e.g., also measured relative to the start time). The distance to the target can be determined as half the product of the time-of-flight and the speed of light. Pulses from the laser device reflect from objects in the scene at different times, depending on start time and distance to the object, and the sensor array detects the pulses of reflected light.

### B. Histogram Signals From Photodetectors

One mode of operation of a lidar system is time-correlated single photon counting (TCSPC), which is based on counting single photons in a periodic signal. This technique works well for low levels of periodic radiation which is suitable in a lidar system. This time correlated counting may be controlled by a periodic signal, e.g., from timing generator 220.

The frequency of the periodic signal can specify a time resolution within which data values of a signal are measured. For example, one measured value can be obtained for each photosensor per cycle of the periodic signal. In some embodiments, the measurement value can be the number of photodetectors that triggered during that cycle. The time period of the periodic signal corresponds to a time bin, with each cycle being a different time bin.

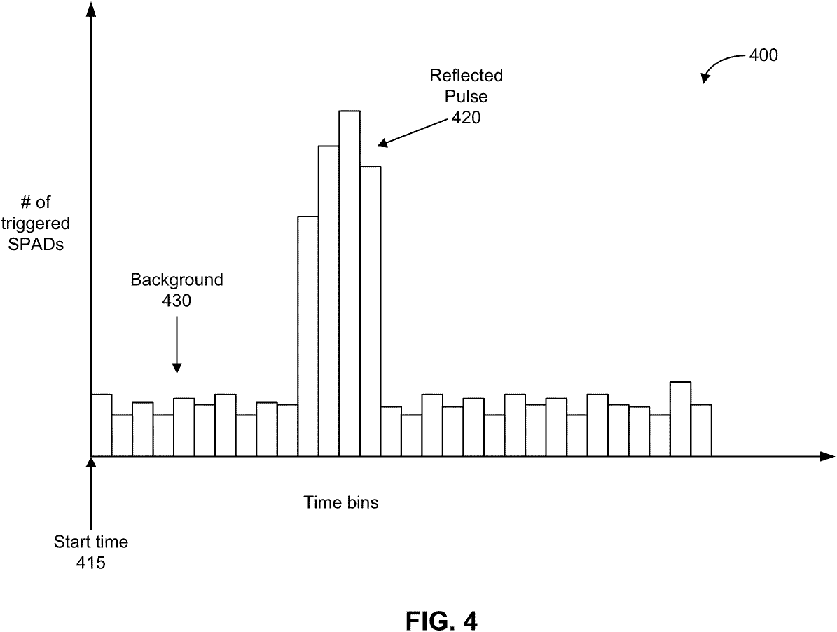

FIG. 4 shows a histogram 400 according to some embodiments described herein. The horizontal axis corresponds to time bins as measured relative to start time 415. As described above, start time 415 can correspond to a start time for an emitted pulse train. Any offsets between rising edges of the first pulse of a pulse train and the start time for either or both of a pulse train and a detection time interval can be accounted for when determining the received time to be used for the time-of-flight measurement. In this example, the sensor pixel includes a number of SPADs, and the vertical axis corresponds to the number of triggered SPADs for each time bin. Other types of photodetectors can also be used. For instance, in embodiments where APDs are used as photodetectors, the vertical axis may correspond to an output of an analog-to-digital converter (ADC) that receives the analog signal from an APD. It is noted that APDs and SPADS can both exhibit saturation effects. Where SPADs are used, a saturation effect can lead to dead time for the pixel (e.g., when all SPADs in the pixel are immediately triggered and no SPADs can respond to later-arriving photons). Where APDs are used, saturation can result in a constant maximum signal rather than the dead-time based effects of SPADs. Some effects can occur for both SPADs and APDs, e.g., pulse smearing of very oblique surfaces may occur for both SPADs and APDs.

The counts of triggered SPADs for each of the time bins correspond to the different bars in histogram 400. The counts at the early time bins are relatively low and correspond to background noise 430. At some point, a reflected pulse 420 is detected. The corresponding counts are much larger, and may be above a threshold that discriminates between background and a detected pulse. The reflected pulse 420 results in increased counts in four time bins, which might result from a laser pulse of a similar width, e.g., a 4 ns pulse when time bins are each 1 ns.

The temporal location of the time bins corresponding to reflected pulse 420 can be used to determine the received time, e.g., relative to start time 415. In some embodiments, matched filters can be used to identify a pulse pattern, thereby effectively increasing the signal-to-noise ratio and allowing a more accurate determination of the received time. In some embodiments, the accuracy of determining a received time can be less than the time resolution of a single time bin. For instance, for a time bin of 1 ns, a resolution of one time bin would correspond to a distance about 15 cm. However, it can be desirable to have an accuracy of only a few centimeters.

Accordingly, a detected photon can result in a particular time bin of the histogram being incremented based on its time of arrival relative to a start signal, e.g., as indicated by start time 415. The start signal can be periodic such that multiple pulse trains are sent during a measurement. Each start signal can be synchronized to a laser pulse train, with multiple start signals causing multiple pulse trains to be transmitted over multiple laser cycles (also sometimes referred to as “shots”). A shot can occur over a detection time interval (also referred to as a detection interval, time interval, or laser cycle). An entire measurement can be over a measurement time interval (or just “measurement interval”), which may equal N detection intervals of an optical measurement or be longer, e.g., when pauses occur between detection intervals. Thus, a time bin (e.g., from 200 to 201 ns after the start signal) would occur for each detection interval. The histogram can accumulate the counts, with the count of a particular time bin corresponding to a sum of the measured data values all occurring in that particular time bin across multiple shots. When the detected photons are histogrammed based on such a technique, the result can be a return signal having a signal to noise ratio greater than that from a single pulse train by the square root of the number of shots taken.

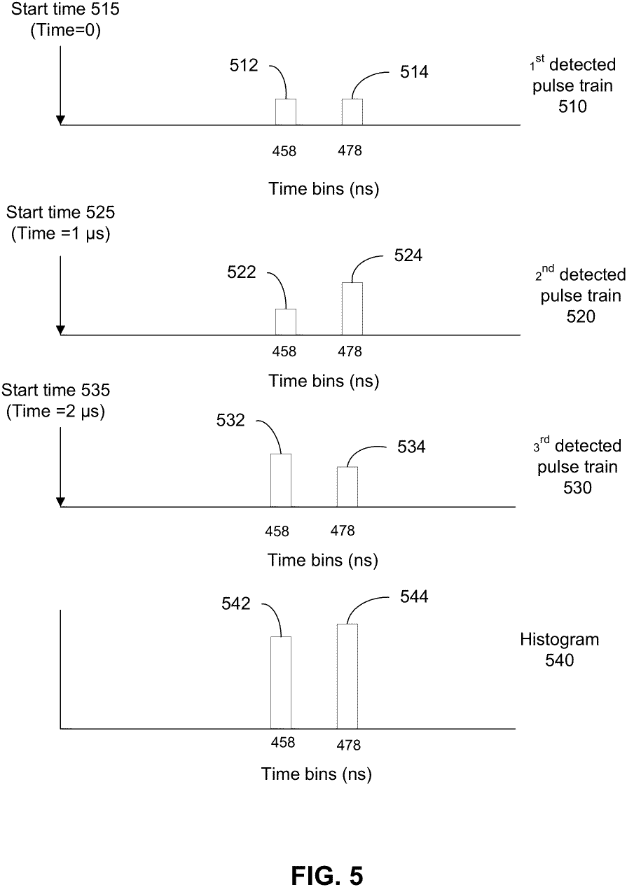

FIG. 5 shows the accumulation of a histogram over multiple pulse trains for a selected pixel according to some embodiments described herein. FIG. 5 shows three detected pulse trains 510, 520 and 530. Each detected pulse train corresponds to a transmitted pulse train that has a same pattern of two pulses separated by a same amount of time. Thus, each detected pulse train has a same pulse pattern, as shown by two time bins having an appreciable value. Counts for other time bins are not shown for simplicity of illustration, although the other time bins may have non-zero values (generally lower than the values in time bins corresponding to detected pulses).

In the first detected pulse train 510, the counts for time bins 512 and 514 are the same. This can result from a same (or approximately the same) number of photodetectors detecting a photon during each of the two time bins, or approximately the same number of photons being detected during the two time bins, depending on the particular photodetectors used. In other embodiments, more than one consecutive time bin can have a non-zero value; but for ease of illustration, individual nonzero time bins have been shown.

Time bins 512 and 514 respectively occur 458 ns and 478 ns after start time 515. The displayed counters for the other detected pulse trains occur at the same time bins relative to their respective start times. In this example, start time 515 is identified as occurring at time 0, but the actual time is arbitrary. The first detection interval for the first detected pulse train can be 1 µs. Thus, the number of time bins measured from start time 515 can be 1,000. After, this first detection interval ends, a new pulse train can be transmitted and detected. The start and end of the different time bins can be controlled by a clock signal, which can be part circuitry that acts as a time-to-digital converter (TDC).

For the second detected pulse train 520, the start time 525 is at 1 µs, at which time the second pulse train can be emitted. Time between start time 515 and start time 525 can be long enough that any pulses transmitted at the beginning of the first detection interval would have already been detected, and thus not cause confusion with pulses detected in the second detection interval. For example, if there is not extra time between shots, then the circuitry could confuse a retroreflective stop sign at 200 m with a much less reflective object at 50 m (assuming a laser cycle of about 1 us). The two detection time intervals for pulse trains 510 and 520 can be the same length and have the same relationship to the respective start time. Time bins 522 and 524 occur at the same relative times of 458 ns and 478 ns as time bins 512 and 514. Thus, when the accumulation step occurs, the corresponding counters can be added. For instance, the counter values at time bin 512 and 522 can be added together.

For the third detected pulse train 530, the start time 535 is at 2 µs, at which time the third pulse train can be emitted. Time bin 532 and 534 also occur at 458 ns and 478 ns relative to start time 535. The counts for corresponding pulses of different pulse trains (as evidenced by the counters) may have different values even though the emitted pulses have a same power, e.g., due to the stochastic nature of the scattering process of light pulses off of objects.

Histogram 540 shows an accumulation of the counts from three detected pulse trains 510, 520, 530 at time bins 542 and 544, which also correspond to 458 ns and 478 ns. Histogram 540 can have fewer time bins than were measured during the respective detection intervals, e.g., as a result of dropping time bins in the beginning or the end of the detection interval or time bins having values less than a threshold. In some implementations, about 10-30 time bins can have appreciable values, depending on the pattern for a pulse train.

As examples, the number of pulse trains emitted during a measurement to create a single histogram can be around 1-40 (e.g., 24), but can also be much higher, e.g., 50, 100, 500, or 1000. Once a measurement is completed, the counts for the histogram can be reset, and another set of pulse trains can be emitted to perform a new measurement. In various embodiments and depending on the number of detection intervals in the respective measurement cycles, measurements can be performed, e.g., every 25, 50, 100, or 500 µs. In some embodiments, measurement intervals can overlap, e.g., so that a given histogram corresponds to a particular sliding window of pulse trains. In such an example, memory can be provided for storing multiple histograms, each corresponding to a different time window. Any weights applied to the detected pulses can be the same for each histogram, or such weights could be independently controlled.

### III. Histogramming Control Logic

To increase the accuracy of a lidar system or make other performance improvements for a particular application, it may be desirable for the system to be configurable in how a histogramming cycle is performed for a pixel. Controlling the histogramming process may be accomplished using an array controller with configuration memory, where the configuration memory may contain configuration values, customizable by a user, that cause the pixel (including related circuitry) to perform a histogramming cycle according to various settings. The configuration values may be histogramming parameters or can be used to retrieve histogramming parameters.

The pixel can include a sensor of one or more photodetectors (e.g., SPADs), memory for storing photon counts per time bin, and related circuitry for input/output and for counting over multiple time intervals (laser cycles).

### A. Structure of a Lidar System

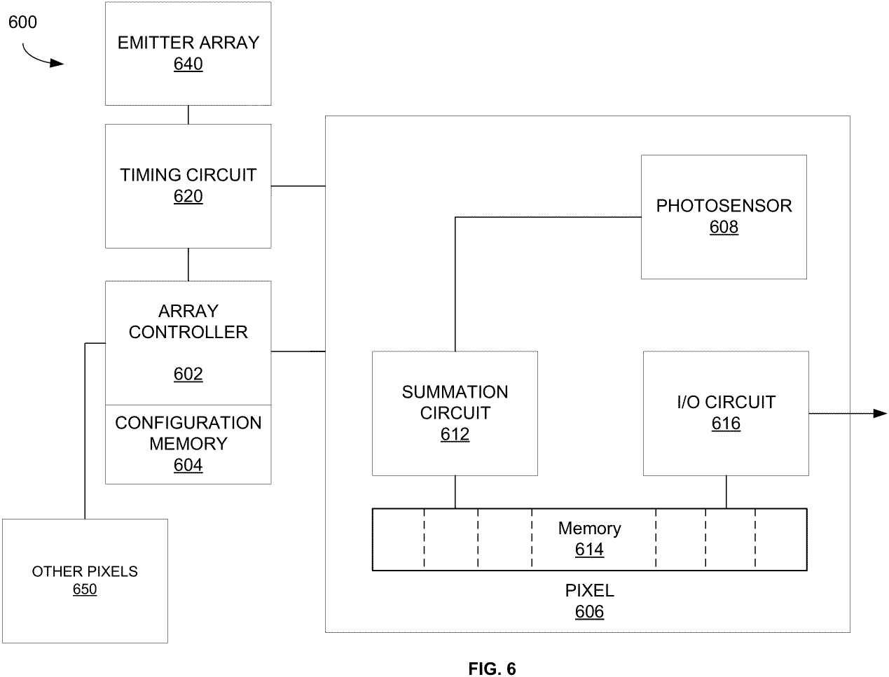

FIG. 6 shows simplified example of a lidar system 600 according to certain embodiments. Lidar system 600 may include an array controller 602, a programmable configuration memory 604 (or “configuration memory”), and a pixel 606. Lidar system 600 may also include a timing circuit 620 and other components, e.g., as described for lidar system 100. The timing circuit 620 may be similar the timing circuit 120 in FIG. 1. The timing circuit 620 may also be connected to an emitter array 640. The emitter array 640 may be similar to the emitter array 230 in FIG. 2, and emit an optical pulse in response to a timing signal from the timing circuit 620.

In some embodiments, the array controller 602 may be implemented by the control circuit 110 from FIG. 1. In other embodiments, the array controller 602 may be implemented separately from the control circuit 110, e.g., on a device such as a Field Programmable Gate Array (FPGA) or other device capable of executing instructions. The configuration memory 604 may include any number of configuration values programmable by a user. The configuration memory 604 may be programmed in various ways, e.g., by configuring an adaptive logic module and/or creating a look up table (LUT) to contain desired configuration values. The array controller 602 may access the configuration values in the configuration memory 604 in order to send control signals to the pixel 606.

The pixel 606 may be similar to the sensors 142 in FIG. 1. The pixel 606 may include components such as a photosensor 608, a summation circuitry 612, a memory 614, and an I/O circuit 616. As an example, the memory can be static random-access memory (SRAM). It should be understood that this is not intended to be limiting, and other types of memory devices such as dynamic random-access memory (DRAM) devices may be employed as well. The pixel 606 and components thereof may be implemented on a single integrated circuit, such as an Application Specific Integrated Circuit (ASIC) or an FPGA. The pixel 606 may also include components (not shown) that enable functions to be performed, such as beginning and ending operation based on a timing signal from the timing circuit 620, initiating a readout of histogram data from the memory 614, and other functions. The memory 614 may be logically divided into memory bins (corresponding to time bins), where histogram data may be stored and organized by time. The time bins are represented by dashed lines dividing the memory 614. Furthermore, although only one pixel 606 is shown, it should be understood that there may be any number of pixels 606 in a pixel array, such as the sensor array 240, as shown by the other pixels 650 each pixel in the other pixels 650 may be identical to the pixel 606. The other pixels 650 may have separate memory use a same larger memory as pixel 606, e.g., a single memory block where different pixels access different portions of the memory block. Timing circuit 620 can also be connected to the other pixels 650.

The array controller 602 may be in communication with the pixel 606. In response to a value in the configuration memory 604, the array controller 602 may send a control signal to the pixel 606, and cause the pixel 606 to perform one or more functions. The functions may include controlling the start of a histogram cycle in relation to a timing signal and/or an optical pulse, which time bins to gather histogram data for a given laser pulse, and whether the pixel 606 and/or other pixels 650 begin histogramming for a given optical pulse.

In some embodiments, the configuration memory 604 may include several configuration values grouped in “modes,” where each mode causes the pixel 606 to operate in a specified manner. Each mode may include one or more functions such as those listed above. The configuration memory 604 may also contain a flag that may be in either an on-state or an off-state for a given mode, or only one mode may be allowed to be selected. If the flag is in the on-state, the array controller 602 may retrieve configuration values (e.g., histogramming parameters) associated with a mode (e.g., as stored in a table in association with a given mode), and send a corresponding control signal(s) to the pixel 606 at one or more times to effectuate the corresponding functions. Accordingly, the array controller can be configured to enter a mode based on one or more of configuration values and obtain one or more histogramming parameters associated with the mode.

The photosensor 608 may be a device capable of registering photon strikes, such as a SPAD. In response to a photon strike, the photosensor 608 may send a signal to the summation circuitry 612. The summation circuitry 612 may be configured to update the photon counts for each of a plurality of time bins at each laser cycle (time interval). For example, a new photon count for a current time bin can be received from photosensor 608, and this new photon count can be added to an existing count stored in memory 614 for that time bin, as described herein. Thus, summation circuitry 612 can determine a current photon count for given time bin during a laser cycle, and read a stored value and write a new value to the memory 614. The summation circuitry 612 adding the current photon count to a pre-existing count stored on memory 614 can create the histogram data that is stored on the memory 614. Accordingly, the pixel 606 may be configured to store the histogram data in a set of consecutive time bins in response to a timing signal provided from the timing circuit 620.

In some embodiments, the control signal provided from the array controller 602 may control the collection of histogram data, some examples of which are described below. The control signal may cause the photosensor 608 to be powered on or off at certain times during a laser cycle. The control signal may also cause the summation circuitry 612 to only operate within certain time bins, resulting in histogram data only being collected for certain time bins.

The I/O circuit 616 may be configured to read/write data from the memory 614, such as to readout histogram data of consecutive time bins from the memory 614. The pixel 606 may initiate a readout by the I/O circuit in response to a timing signal at the end of a laser cycle. In some embodiments, the pixel 606 may initiate a readout by the I/O circuit 616 in response to a control signal from the array controller 602.

The I/O circuit 616 may generate a readout the histogram data of consecutive time bines to another device outside of the pixel, represented by an arrow pointing off the pixel 606. Although the readout is being sent to the other device off the pixel 606, in some embodiments, the other device may be circuitry on the same chip as the pixel array. In some embodiments, the other device may be the array controller 602. The other device may be operable to analyze the histogram data to perform peak detection to determine the distance to an object based on results of the peak detection. Thus, the pixel 606 nay be configured to generate histogram data for a set of consecutive time bins.

### B. Start Signals May Be Controlled on a Per-Shot Basis

In some embodiments, each pixel in an array can start and stop at various times (e.g., at one or more times during shot) during a histogramming cycle in coordination with laser pulses, or shots. A laser cycle may include the powering on and off of one or more lasers included in an emitter array to generate a shot. The emitter array may emit one or more shots within a frame, where the frame corresponds to an image measurement. The histogramming cycle may include counting a number of photons received and storing the photon count for each shot in a corresponding time bin(e.g., 200 ns after the emission of a laser pulse). A histogram may then be created by combining the histogram data of each shot within the frame.

Each pixel may begin histogramming at some time after a start signal is received from an array controller 602. The start signal may include instructions that cause one or more components of the pixel to operate according to certain histogramming parameters, as described below. Each pixel in an array may have an offset, dependent on each shot within a frame, where the pixel begins histogramming at some time after the start signal for a given shot is received. The offset may be due to reasons such as the power management of the array and the precision of the array. Thus, each pixel must be configurable to begin histogramming on a per-shot basis.

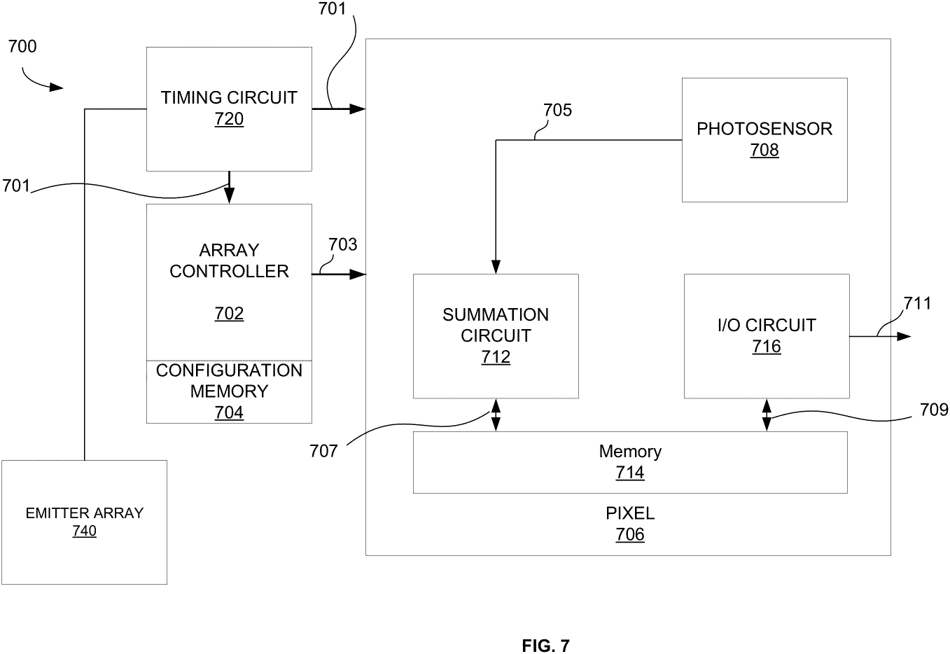

FIG. 7 shows a system for controlling a histogramming start time on a per-shot basis according to certain embodiments. The lidar system 700 may utilize the same components shown in the lidar system 600 in FIG. 6. As such, an array controller 702, a configuration memory 704, a pixel 706—including a photosensor 708, a summation circuitry 712, an I/O circuit 716, and a memory 714 may be identical to the corresponding counterparts in FIG. 6. Furthermore, although only one pixel 706 is shown, there may be any number of pixels in a pixel array, e.g., corresponding to sensor array 240. For simplicity, other pixels such as other pixels 650 are not shown, but should be understood to be present in the lidar system 700.

The array controller 702 may be in a first mode associated with one or more configuration values stored in the configuration memory 704. The configuration values in the configuration memory 704 may correspond to a histogramming start time, e.g., a clock cycle relative to, for example, when light was emitted from a light source. The start time can specify when to start histogramming, e.g., by turning on the circuitry, such as photosensor 708 and summation circuitry 712. In other example, the start signal can identify which clock cycle to identify as time bin 1, and then histogramming can actually start at a later time at a specified time bin, which may be defined on a per shot basis. Such selection of time bins is described in more detail in a later section.

The specific histogramming start time used for the pixel 706 can be defined on a per shot basis, where multiple shots and the corresponding counts create a frame (image measurement). The configuration values in the configuration memory 704 may cause a histogramming start time for the pixel 706 to be different for each shot within a frame for a given pixel. Additionally, each pixel in an array of pixels (such as pixel 606 and other pixels 650 in FIG. 6) may have a different histogramming start time for each shot within a frame. Each pixel may be independently configurable as to its histogramming start time. The configurability of when each pixel starts histogramming per shot allows for an end user to account for various delays in a chip and to perform various functions, e.g., to focus on a given measurement or laser cycle on a long range measurement or a short range measurement. Since the configuration can be performed for array controller 702, the manufacture of pixel 706 can be simplified.

The array controller 702 and/or the pixel 706 may receive a timing signal 701 from the timing circuit 720, indicating that a laser cycle has started. The timing signal 701 may be associated with an optical signal (or a shot) emitted from emitter array 740. In accordance with the one or more configuration values in the configuration memory 704, the array controller 702 may send a START signal 703 to the pixel 706. In some embodiments, the array controller 702 may send a respective START signal 703 in response to each shot emitted by emitter array 740. In some embodiments, the array controller 702 only sends a new START signal to the pixel 706 when a mode changes. Thus, the pixel 706 may operate in accordance with the START signal 703 until a new START signal is received from the array controller 702.

In some embodiments, the pixel 706 is just one pixel in array of pixels. Each pixel in the array of pixels may therefore have a different histogramming start time, as discussed above. The array controller 702 may send the START signal to each pixel in the array of pixels. The START signal may include histogramming start times for each pixel. In this case, each pixel may store the START signal and therefore have the histogramming start times for each pixel in the array stored in the SRAM. In other embodiments, the array controller 702 may send a START signal to each pixel, e.g., by specifying a particular pixel for routing purposes.

In accordance with the START signal 703, the pixel 706 may begin a histogramming cycle. The START signal 703 may be sent to the pixel 706 at any time, even if a previous histogramming cycle is already in progress. In this case, the START signal 703 may cause the previous histogramming cycle to be stopped and a new histogramming cycle to begin.

The histogramming cycle may cause one or more processes to be performed by pixel 706. The histogramming cycle may include causing the photosensor 708 to begin operation, causing the summation circuitry 712 to begin adding photon counts and storing histogram data in the memory 714 where the histogram data is stored in time bin-by-time bin basis, and causing the I/O circuit to read out the histogram data from the memory 714. In some embodiments, the photosensor 708 may be operating prior to the START signal, while the other components, such as the summation circuitry 712 are not. In this case, although the photosensor is operating, histogram data is not being collected until the START signal is received. The photosensor 708 may include one or more photodetectors, such as SPADS.

Photons may strike the photosensor 708, whether the photons are from ambient light or a reflected laser pulse. The photosensor 708 may then send a detection signal 705 to the summation circuitry 712 in response to a photon strike. In some embodiments, the detection signal 705 is digitized (such as in the case of a SPAD), meaning that a photon count may be determined. The summation circuitry 712 may then count the detection signals received by the photosensor 708 during the histogramming cycle, creating a photon count. Multiple detection signals 705 may be transmitted to the summation circuitry 712. As the detection signals 705 may be transmitted at different times, the detection signals may be organized by the time bin in which they are received. The photon count, therefore, may also be organized by time bin.

Through communication 707, the summation circuitry 710 may access a previous photon count for each time bin, as determined by the timing circuit 720 and in relation to the emission of a shot, stored at the memory 714. The summation circuitry 712 may then add the photon count to the previous photon count for each time bin, and store resulting histogram data at the memory 714.

The pixel 706 may determine that a predetermined number of clock cycles has passed and stop the histogramming cycle. In some embodiments, the histogram data may be readout by the I/O circuit 716 from the memory 714 at the end of the histogramming cycle via communication 709. The pixel 706 may determine a range of time bins to readout by the I/O circuit 716 based on the number of clock cycles that has passed. In some embodiments, the range of time bins may correspond to an offset in histogramming start time associated with the pixel 706.

In other embodiments, the array controller 702 may send a readout request that causes the histogram data to be read out by the I/O circuit 716. The histogram data may be sent through a readout 711 to an external system (e.g., a processor, which may be on a same or different integrated circuit) and analyzed to detect a peak that corresponds to a distance to an object for a given pixel. In some embodiments, the memory 714 may be cleared at the end of the histogramming cycle, resetting the previous photon count to zero. The histogramming cycle may then restart in accordance with the START signal, or may not begin until a second START signal is received by the pixel 706.

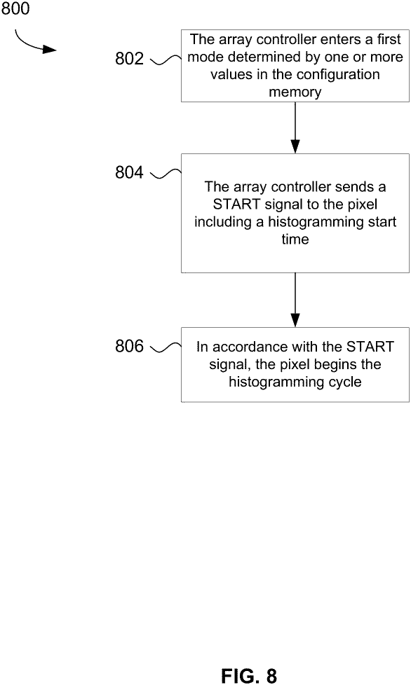

FIG. 8 shows a method of controlling a histogramming start time on a per-shot basis according to certain embodiments. The method 800 may be executed utilizing the systems and processes discussed above, in particular the lidar system 600 in FIG. 6 and/or the lidar system 700 in FIG. 7.

At 802, an array controller enters a first mode, where the first mode is determined by one or more configuration values stored in a configuration memory. The configuration values in the configuration memory may correspond to one or more settings for a pixel in a pixel array. The settings may include a histogramming start time, where the pixel begins collecting histogram data at the histogramming start time. The histogramming start time may be determined by a number of clock cycles counted from the emission of an optical pulse or shot. Thus, the start time (e.g., specified clock cycles) may be determined using a timing signal from a timing circuit, such as timing circuits 120, 620, and 720 in FIGS. 1, 6, and 7.

At 804 the array controller sends a START signal to the pixel. The START signal may specify a histogramming start time or cause immediate histrogramming when received. The histogramming start time may be determined from a predetermined number of clock cycles, e.g., as counted from the emission of a shot from an emitter, such as emitter array 740 in FIG. 7. The histogramming start time can specify particular time bins, which may be defined relative to a timing signal from a timing circuit, such as timing circuits 120, 620, and 720 of FIGS. 1, 6, and 7. The START signal may include separate histogramming start times for each shot within the frame. Additionally, the START signal may include different histogramming start times for each pixel in the pixel array for each shot in the frame. The START signal may be a set of signals that are sent at respective times, e.g., when start times vary per pixel.

At 806, the pixel begins a histogramming cycle in accordance with the START signal at the histogramming start time as determined by a timing signal, received from the timing circuit. The histogramming cycle may include the configuration memory registering photon strikes on a photodetector, and creating a photon count for one or more corresponding time bins. The histogramming cycle may also include counting photon strikes, adding the photon strikes to a pre-existing photon count for each corresponding time bin, creating histogram data, and storing the histogram data at a temporary memory. The histogramming cycle may also include reading out the histogram data to an external device. Circuitry included on the pixel may cause the histogram data to be read out upon a certain time, ascertained from the timing circuit. In some embodiments, the array controller may cause the histogram data to be read out. The entire histogram data may be read out, or just histogram data for certain time bins as determined by a timing offset measured from the emission of the shot.

### C. Histogram Readouts During a Histogramming Cycle

Certain lidar applications may require a readout of histogramming data in the middle of a histogramming cycle. For example, in a high-dynamic range scheme, optical pulses (or “shots”) of differing powers may be emitted during a frame. The histogramming cycle may include generating a histogram of all of the shots included in the frame. In this example, a first laser pulse may be emitted at a first power, and then a second pulse emitted at a second power. To differentiate between the data associated with each pulse, two readouts of the histogram data may be required. The first readout may contain only histogram data associated with the first optical pulse and require readout prior to the completing of the frame. The second readout may contain data associated with both optical pulses. By analyzing the differences in the histogram data between the first and second readouts, a more accurate range may be found to objects that are either changing distance or to multiple objects of different distances.

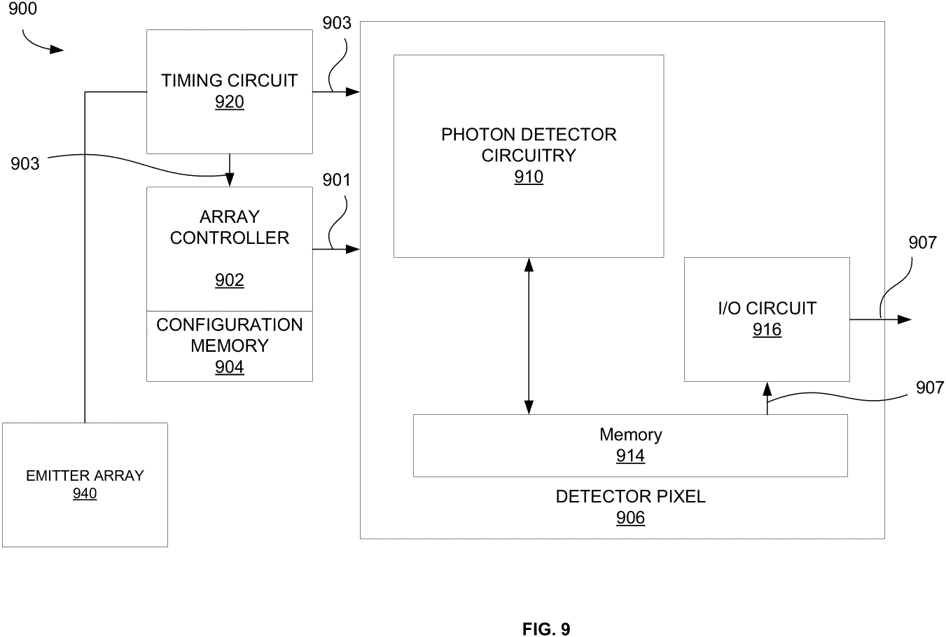

FIG. 9 shows a system for reading out histogram data during a histogramming cycle, act cording to certain embodiments. The lidar system 900 may utilize the same components shown in the lidar system 600 in FIG. 6. As such, an array controller 902, a configuration memory 904, and a pixel 906 may be identical to their corresponding counterparts in FIG. 6. A photon detector circuitry 910 may have identical functionality to the photosensor 608, and a summation circuitry 612 in FIG. 6. Similarly, the I/O circuit 916, and a memory 714 may be identical to their corresponding counterparts in FIG. 6. Furthermore, although only one pixel 906 is shown, there may be any number of pixels in a detector array, such as in sensor array 240. A timing circuit 920 may be similar to timing circuits 120, 620, and 720 in FIGS. 1, 6, and 7. Other pixels may be included (e.g., in an array) and are omitted for ease of illustration.

The array controller 902 may be in a mode based on one or more configuration values entered into the configuration memory 904. The configuration values in the configuration memory 904 may be associated with one or more readout times, where histogram data is desired during a histogramming cycle. The array controller 902 may send a control signal 901 to the pixel 906 that causes the pixel 906 to schedule a readout of the histogram data at a certain time. The readout may include some time bins but exclude others.

The array controller 902 and the pixel 906 may receive a timing signal 903 from the timing circuit 920. In response to the timing signal 903, the pixel 906 may begin a histogramming cycle. The histogramming cycle may begin at a predetermined number of clock cycles after the emission of a shot, as is described in FIG. 7. Multiple shots may be included in a frame. The photon detector circuitry 910 may perform operations such as those described above in FIG. 6. The photon detector circuitry 910 may cause histogram data to be stored on the memory 914 during the histogramming cycle via communication 905.

In accordance with the control signal sent by the array controller 902, pixel 906 may cause the I/O circuit 916 to generate a readout 907 including histogram data read out of memory 914 after a predetermined number of shots (“N shots”), the number of shots being less than the total shots included in the frame. In some embodiments, the pixel 906 may cause the I/O circuit 916 to readout the histogram data after N shots in accordance with the control signal 901. In other embodiments, the array controller 902 may send a signal to cause the I/O circuit to generate the readout 907. The signal may cause a scheduled readout such as readout 907, or may be in addition to any scheduled readouts. The pixel 906 and/or the array controller 902 may cause the I/O circuit 916 to generate the readout 907 based on a number of clock cycles or time bins passed after the pixel 906 began histogramming. In some embodiments, the histogram data for a first range of time bins is readout, while the histogram data for a second range of time bins is not readout.

In some embodiments, the pixel 906 may cause the I/O circuit 916 to cause the readout of histogram data while the photon detector circuitry 910 continues performing the histogramming cycle. During a frame, multiple shots may be emitted by the emitter array 940. While there may be little time between shots in the frame, there may be times between shots where no optical pulse is being emitted. Therefore, the I/O circuit 916 may begin the readout after a previous shot, but before the current shot, in order to complete the readout before the frame completed.

In some embodiments, the I/O circuit 916 may not cause the histogram data to be deleted when readout during the histogramming cycle. In that case, the photon detector circuitry 910 may continue to access a previous photon count and add a new photon count during the histogramming cycle. By performing a readout during a histogramming cycle, better performance may be enabled.

In some embodiments, histogram data readout while a histogramming cycle is in progress, functions such as high-dynamic range may be achieved. The first laser pulse may be characterized by a first power level, and the second laser pulse may be characterized by a second power level, less than the first power level. Thus, the photons collected from the first pulse may be represented in the first readout, while photons from the first pulse and the second pulse may be represented in the second read out. Because the first and second pulses may have differing power levels, the corresponding readout may be more or less responsive to target of varying distances. Thus, accurate ranges may be found in the case where a target is changing distance to the pixel array, and the case where there are multiple targets of varying distances to the pixel array

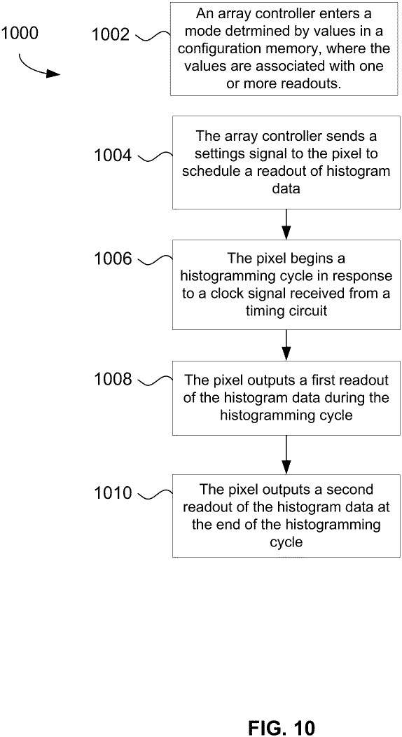

FIG. 10 shows a method of reading out histogram data during a histogramming cycle, according to certain embodiments. The method 1000 may be executed utilizing the systems and processes discussed above, such as the lidar system 600 in FIG. 6, lidar system 700 in FIG. 7, or the lidar system 900 in FIG. 9.

At 1002, an array controller may enter a mode based on one or more configuration values in a configuration memory. The configuration values in the configuration memory may be associated with one or more readout times, where histogram data is desired during a histogramming cycle. In some embodiments, the desired readouts of the histogram data may include some time bins but exclude other time bins. In some embodiments, no readouts are desired.

At 1004, the array controller may send a control signal to a pixel that causes the pixel to schedule a readout of histogram data. The scheduled histogram data readout may occur immediately or at a later specified or default time. The pixel may store the control signal in a memory device such as Static Random Access Memory (SRAM), such as memory 914 in FIG. 9. The control signal may include instructions causing a readout to be generated by the pixel after a predetermined number of shots, the number of shots being less than that included in a frame. The control signal may include instructions causing a readout to be generated by the pixel after a certain number of clock cycles or time bins.

At 1006, the pixel may begin a histogramming cycle in response to a timing signal received from a timing circuit. The timing signal may be associated with a shot emitted from an emitter array such as emitter array 940 in FIG. 9. In some embodiments, the pixel may begin histogramming in accordance with a START signal such as START signal 703 in FIG. 7. The histogramming cycle may include counting photon strikes, adding the photon strikes to a pre-existing photon count creating histogram data, and storing the histogram data at a SRAM, such as memory 914 in FIG. 9.

At 1008, the pixel outputs a first readout of the histogram data during the histogramming cycle. In some embodiments, the first readout is output in accordance with the control signal. In other embodiments, the array controller may send a signal that causes the pixel to output the first readout. The pixel may output the first readout after a predetermined number of shots, the number of shots being less than the number of shots included in a frame. The pixel may also output the readout after a certain number of clock cycles or time bins. In some embodiments, the histogram data included in the first readout is deleted from the SRAM. In other embodiments, the histogram data included in the first readout remains in the SRAM after the first readout.

At 1010, the pixel outputs a second readout of the histogram data at the end of the histogramming cycle. The histogram data may be deleted from the temporary memory. In some embodiments, the histogram data for a first range of time bins is readout, while the histogram data for a second range of time bins is not readout.

In some embodiments, histogram data readout while a histogramming cycle is in progress may enable functions such as dynamic range finding. The first laser pulse may be characterized by a first power level, and the second laser pulse may be characterized by a second power level, less than the first power level. Thus, the photons collected from the first pulse may be represented in the first readout, while photons from the first pulse and the second pulse may be represented in the second read out. Because the first and second pulses may have differing power levels, the corresponding readout may be more or less responsive to target of varying distances. Thus, accurate ranges may be found in the case where a target is changing distance to the pixel array, and the case where there are multiple targets of varying distances to the pixel array

### D. Programmable Time Bin Histogramming

There may be applications in lidar ranging that do not require a histogram constructed from every available time bin. For example, if there is a distance of interest where an object is expected to be or a where an unexpected object is detected, limiting a histogramming cycle to only include a limited histogramming time bin range may be desired.

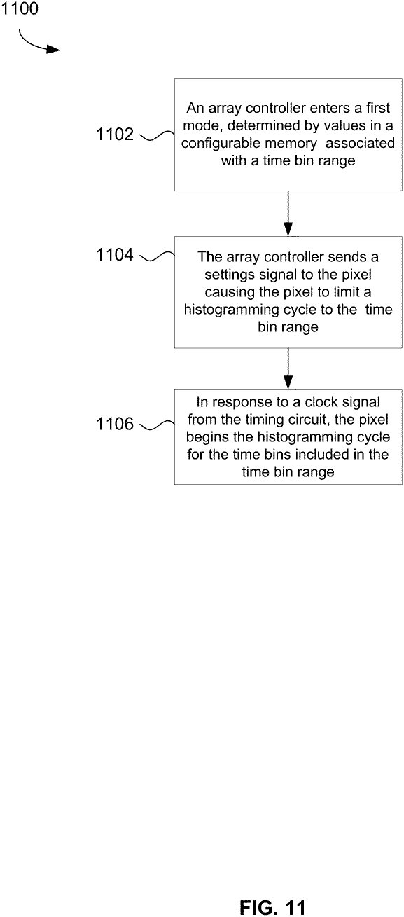

FIG. 11 shows a method of limiting a pixel histogram by histogramming time bin range, according to certain embodiments. The method 1100 may be performed by the systems and processes discussed above, such as the lidar system 600 in FIG. 6.

At 1102, an array controller may enter a first mode based on a first set of configuration values in a configuration memory. The first set of configuration values may be associated with a histogramming time bin range. For example, the first histogramming time bin range may include all possible time bins. The first set of configuration values may have been programmed by a user by entering the set of configuration values in the configuration memory.

At 1104, the array controller may send a control signal to a pixel, causing the pixel to limit a histogramming cycle to the histogramming time bin range. The histogramming time bin range may include a minimum time bin and a maximum time bin. In some embodiments, the histogram cycle may include multiple histogramming time bin ranges, where the multiple histogramming time bin ranges are non-consecutive. In some embodiments, the first bin range may include all time bins for a frame. In relation to FIG. 6, the first control signal may cause the pixel 606 to cause the photosensor 608 to be powered off. In other embodiments, the pixel 606 may cause the summation circuitry 612 to not write histogram data to the MEMORY 614 except for time bins within the histogramming time bin range. In yet other embodiments, the pixel 606 may limit a readout of histogram data by the I/O circuit 616 to only readout time bins within the histogramming time bin range.

At 1106, the pixel may begin a histogramming cycle in response to receiving a timing signal from a timing circuit for the time bins included in the histogramming time bin range. The timing signal may be associated with a shot emitted from an emitter array such as emitter array 640 in FIG. 6. In some embodiments, the pixel may begin histogramming in accordance with a START signal such as START signal 703 in FIG. 7. The control signal may be included with the START signal 703. The histogramming cycle may include counting photon strikes, adding the photon strikes to a pre-existing photon count creating histogram data, and storing the histogram data at a SRAM, such as MEMORY 614 in FIG. 6.

The histogramming cycle may be limited by the control signal. The pixel may power off a photosensor for all time bins not included in the histogramming time bin range. The pixel may not write histogram data to a SRAM for time bins not included in the histogramming time bin range. The pixel may only readout histogram data for those time bins included in the histogramming time bin range.

In some embodiments, each pixel in a pixel array may have a histogramming time bin range, different than histogramming time bin ranges associated with other pixels in the pixel array. Each pixel may receive the control signal from the array controller, where the control signal includes histogramming time bin ranges for every pixel in the array.

Although FIGS. 6-11 describe processes and methods in isolation, any number of these functions may be combined into a single process. For example, the array controller 602, described in FIG. 6, may be in a mode, based on configuration values in the configuration memory 604 that are associated with various start times on a per-shot basis, configuration values associated with scheduled readout times (as described in FIG. 9), and configuration values associated with a limited histogramming time bin range (as disclosed in FIG. 11). The array controller 602 may then send a START signal to the pixel 606 in accordance with all of these configuration values. Thus, the pixel 606 may perform the processes and methods described in FIGS. 6-11 in response to one signal from the array controller 602.

### IV. Multiple Lidar Units

Depending on their intended purpose or application, lidar sensors can be designed to meet different FOV and different range requirements. For example, an automobile (e.g., a passenger car) outfitted with lidar for autonomous driving might be outfitted with multiple separate lidar sensors including a forward-facing long range lidar sensor, a rear-facing short range lidar sensor and one or more short range lidar sensors along each side of the car.

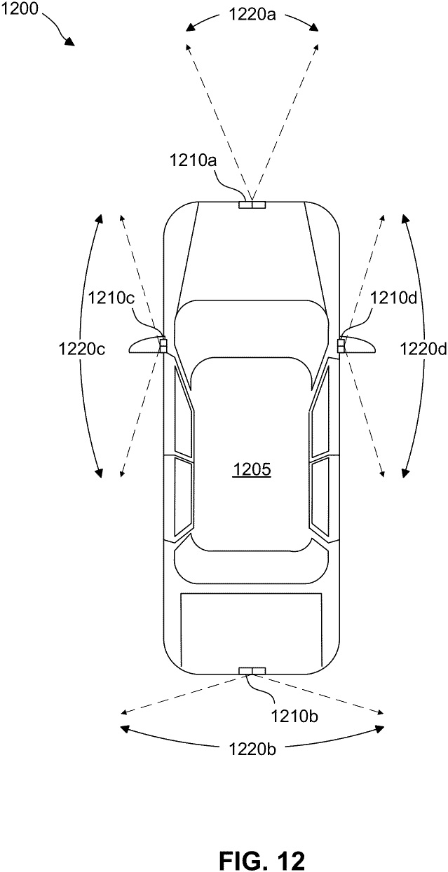

FIG. 12 is a simplified illustration of an automobile 1200 in which four solid-state flash lidar sensors 1210a-d are included at different locations along the automobile. The number of lidar sensors, the placement of the lidar sensors, and the fields of view of each individual lidar sensors can be chosen to obtain a majority of, if not the entirety of, a 360-degree field of view of the environment surrounding the vehicle some portions of which can be optimized for different ranges. For example, lidar sensor 1210a, which is shown in FIG. 10 as being positioned along the front bumper of automobile 1200, can be a long range (200 meter), narrow field of view unit, while lidar sensors 1210b, positioned along the rear bumper, and lidar systems 1210c, 1210d, positioned at the side mirrors, are short range (50 meter), wide field of view systems.

Despite being designed for different ranges and different fields of view, each of the lidar sensors 1210a-1210d can be a lidar system according to embodiments disclosed herein. Indeed, in some embodiments, the only difference between each of the lidar sensors 1210a-1210d is the properties of the diffuser (e.g., diffuser 136). For example, in long range, narrow field of view lidar sensor 1210a, the diffuser 136 is engineered to concentrate the light emitted by the emitter array of the lidar system over a relatively narrow range enabling the long-distance operation of the sensor. In the short range, wide field of view lidar sensor 110b, the diffuser 136 can be engineered to spread the light emitted by the emitter array over a wide angle (e.g., 180 degrees). In each of the lidar sensors 1210a and 1210b, the same emitter array, the same detector array and the same controller, etc. can be used thus simplifying the manufacture of multiple different lidar sensors tailored for different purposes.

Any or all of lidar sensors 1210a-1210d can incorporate use of a controller for controlling histogramming of pixels. Certain applications may require finer control over how a histogram is generated. For example, sensor timing offsets due to power management concerns and precision improvements may require different modes and measurements. Other examples may include adapting a lidar system to operate in different modes. Certain embodiments can provide a need to control the in-pixel histogramming process.

### V. Additional Embodiments

In the above detailed description, numerous specific details are set forth to provide a thorough understanding of embodiments of the present disclosure. However, it will be understood by those skilled in the art that the present disclosure can be practiced without these specific details. For example, while various embodiments set forth above described may use SPADs, other detectors can be employed in embodiments. As another example, some of the embodiments discussed above include a specific number of rows and/or columns of sensors or detectors within a sensor. It is to be understood that those embodiments are for illustrative purposes only and embodiments are not limited to any particular number of columns or rows of sensors or detectors within a sensor.

Any of the computer systems or circuits mentioned herein may utilize any suitable number of subsystems. The subsystems can be connected via a system bus. As examples, subsystems can include input/output (I/O) devices, system memory, storage device(s), and network adapter(s) (e.g., Ethernet, Wi-Fi, etc.), which can be used to connect a computer system to other devices (e.g., an engine control unit). System memory and/or storage device(s) may embody a computer readable medium.

A computer system can include a plurality of the same components or subsystems, e.g., connected together by external interface, by an internal interface, or via removable storage devices that can be connected and removed from one component to another component. In some embodiments, computer systems, subsystem, or apparatuses can communicate over a network.

Aspects of embodiments can be implemented in the form of control logic using hardware circuitry (e.g., an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed is:

1. A lidar system comprising:
a programmable configuration memory configured to receive configuration values for controlling histogramming operations performed by the lidar system;
an array controller configured to read the configuration values and send control signals according to the configuration values in the programmable configuration memory; and
a pixel array configured to receive the control signals from the array controller, wherein the pixel array comprises a plurality of pixels that each include a photosensor, summation circuitry, and memory, wherein each of the plurality of pixels is configured to generate histogram data by collecting photon counts during a plurality of time bins for each of a plurality of laser cycles.

2. The lidar system of claim 1, wherein the array controller is configured to:
enter a mode based on one or more of configuration values; and
obtain one or more histogramming parameters.

3. The lidar system of claim 2, wherein the one or more histogramming parameters comprise a histogramming start time, a histogramming time bin range, and a scheduled readout of histogram data.

4. The lidar system of claim 1, wherein the plurality of pixels are configured to collect the photon counts at a histogramming start time associated with each of the plurality of laser cycles in accordance with the control signals.

5. The lidar system of claim 4, wherein the histogramming start time for each of the plurality of pixels is independently configurable.

6. The lidar system of claim 1, wherein the pixel array is configured generate a readout of histogram data during a histogramming cycle in accordance with the control signals.

7. The lidar system of claim 6, wherein the readout of histogram data is generated after a predetermined number of time bins, counted from a first time bin, in accordance with the control signals.

8. The lidar system of claim 6, wherein the readout of histogram data is generated after a predetermined number of laser cycles in accordance with the control signals.

9. The lidar system of claim 8, wherein the readout of histogram data is generated in between the plurality of laser cycles.

10. The lidar system of claim 1, wherein the control signals specify a histogramming time bin range comprising a set of consecutive time bins, wherein each of the plurality of pixels is configured to generate the histogram data for the time bins in the histogramming time bin range.

11. The lidar system of claim 10, wherein the histogramming time bin range is less than a total number of time bins comprised in a laser cycle.

12. A method of using a lidar system, the method comprising:
storing, in a programmable configuration memory of the lidar system, configuration values for controlling histogramming operations performed by the lidar system;
reading, using an array controller of the lidar system, the configuration values;
sending, using the array controller of the lidar system, control signals according to the configuration values in the programmable configuration memory;
receiving, by a pixel array of the lidar system, the control signals from the array controller, wherein the pixel array comprises a plurality of pixels that each include a photosensor, summation circuitry, and memory; and
generating, using each of the plurality of pixels, histogram data by collecting photon counts during a plurality of time bins for each of a plurality of laser cycles.

13. The method of claim 12, further comprising performing, by the array controller:
entering a mode based on one or more of configuration values; and
obtaining one or more histogramming parameters.

14. The method of claim 13, wherein the one or more histogramming parameters comprise a histogramming start time, a histogramming time bin range, and a scheduled readout of histogram data.

15. The method of claim 12, wherein the plurality of pixels are configured to collect the photon counts at a histogramming start time associated with each of the plurality of laser cycles in accordance with the control signals.

16. The method of claim 15, wherein the histogramming start time for each of the plurality of pixels is independently configurable.

17. The method of claim 12, wherein the pixel array is configured generate a readout of histogram data during a histogramming cycle in accordance with the control signals.

18. The method of claim 17, wherein the readout of histogram data is generated after a predetermined number of time bins, counted from a first time bin, in accordance with the control signals.

19. The method of claim 17, wherein the readout of histogram data is generated after a predetermined number of laser cycles in accordance with the control signals.

20. The method of claim 12, wherein the control signals specify a histogramming time bin range comprising a set of consecutive time bins, wherein each of the plurality of pixels is configured to generate the histogram data for the time bins in the histogramming time bin range.
